(19) United States
(12) Patent Application Publication
(10) Pub. No.: US 2012/0202051 A1
(43) Pub. Date: Aug. 9, 2012

(54) ADHESIVE TAPE FOR NON-AQUEOUS BATTERY

(75) Inventors: Toru ISEKI, Ibaraki-shi (JP); Jun IWATA, Ibaraki-shi (JP)

(73) Assignee: NITTO DENKO CORPORATION, Osaka (JP)

(21) Appl. No.: 13/365,500

(22) Filed: Feb. 3, 2012

(30) Foreign Application Priority Data
Feb. 4, 2011 (JP) 2011-023222

(51) Int. Cl. C09J 7/02; B32B 5/00

(52) U.S. Cl. 428/334; 428/355 EN

(57) ABSTRACT

The present invention provides an adhesive tape for non-aqueous battery, comprising a substrate and an adhesive layer laminated on at least one surface of the substrate, wherein the adhesive layer is made of an adhesive comprising a polyolefin (a), a hydroxyl group-containing polyolefin (b) and a crosslinking agent (c) having a functional group capable of reacting with the hydroxyl group.

### TECHNICAL FIELD OF THE INVENTION

The present invention relates to an adhesive tape for non-aqueous battery. In the present invention, the “adhesive tape for non-aqueous battery” means an adhesive tape used for the production of a non-aqueous battery, and “non-aqueous battery” means a battery wherein a non-aqueous electrolytic solution is encapsulated.

### BACKGROUND OF THE INVENTION

For production of a non-aqueous battery such as lithium-ion battery and the like, an adhesive tape is used for fixing a core, insulating an outlet of an electrode, fixing a terminal or insulating a spacer and the like, improving packing of electrode in a battery casing, or preventing short-circuit between electrodes due to penetration of a separator with burr present in a polar plate. As such adhesive tape for non-aqueous battery, an adhesive tape having an acrylic adhesive layer or a natural rubber-based adhesive layer (hereinafter sometimes to be abbreviated as an “acrylic adhesive tape” and a “natural rubber-based adhesive tape”, respectively) is frequently used.

However, an adhesive tape for non-aqueous battery has a problematic phenomenon of protrusion of an adhesive layer from the substrate (so-called adhesive extrusion). To be specific, as a result of adhesive extrusion, a functional group contained in an adhesive layer of an acrylic adhesive tape, or a double bond contained in an adhesive layer of a natural rubber-based adhesive tape sometimes undergoes a chemical reaction with an electrolyte in an electrolytic solution to cause degradation of non-aqueous battery. To prevent such degradation of a battery, for example, patent document 1 discloses an adhesive tape for battery, having an adhesive layer containing a polyisobutylene rubber and a saturated hydrocarbon resin on the surface of a polypropylene film substrate.

Polyolefin-based adhesives containing polyolefin (particularly rubber-based adhesives containing a rubber such as polyisobutylene) are known to have poor adhesiveness to ordinary substrates (e.g., polyester substrates, polyolefin substrates) (“adhesiveness to substrates” is hereinafter sometimes abbreviated as “an anchor property”). Disclosed techniques for improving the anchor property include, for example, interlaying an undercoat layer between a rubber-based adhesive layer and a substrate (support) (patent document 2).

### DOCUMENT LIST

### Patent Documents

patent document 1: JP-A-9-165557
patent document 2: JP-A-4-370179

### SUMMARY OF THE INVENTION

### Problems to be Solved by the Invention

In general, an adhesive tape is produced by applying an adhesive solution to a substrate, removing the solvent by drying by heating to form an adhesive layer on the substrate, and winding the obtained adhesive tape in a roll. During the winding, the adhesive tape may show residual elongation. As a result, a tension toward the core may be developed due to the residual elongation in a roll-shaped adhesive tape, and a bamboo shoot-like shape (telescopic shape) with an extruded central part may be formed. This phenomenon is called a bamboo-shoot phenomenon. When an adhesive layer of an adhesive tape is free of a crosslinking structure (e.g., the adhesive tape described in patent document 1), a roll-shaped adhesive tape is deformed due to the bamboo-shoot phenomenon, as shown in the following Examples.

As mentioned above, moreover, a polyolefin-based adhesive is known to show poor anchor property. Formation of an undercoat layer as described in patent document 2 is not preferable, since steps and equipment therefor are necessary.

The present invention has been made by noting the above-mentioned circumstances, and aims to provide an adhesive tape for non-aqueous battery, wherein deformation of a roll-shaped adhesive tape due to a bamboo-shoot phenomenon is effectively prevented and an adhesive layer is sufficiently adhered to the substrate even without an undercoat layer.

### Means of Solving the Problems

The present inventors have conducted intensive studies and found that an adhesive tape for non-aqueous battery, having an adhesive layer made of an adhesive containing polyolefin (a), hydroxyl group-containing polyolefin (b) and (c) a crosslinking agent having a functional group capable of reacting with the hydroxyl group can achieve the above-mentioned object. The present invention based on this finding is as described below.

[1] An adhesive tape for non-aqueous battery, comprising a substrate and an adhesive layer laminated on at least one surface of the substrate, wherein the adhesive layer is made of an adhesive comprising a polyolefin (a), a hydroxyl group-containing polyolefin (b) and a crosslinking agent (c) having a functional group capable of reacting with the hydroxyl group.
[2] The adhesive tape according to [1] above, wherein the crosslinking agent (c) is an isocyanate.
[3] The adhesive tape according to [1] or [2] above, wherein the content of the crosslinking agent (c) in the adhesive is 0.01 to 150 parts by weight relative to 100 parts by weight of the polyolefin (a).
[4] The adhesive tape according to any one of [1] to [3] above, wherein the value of A represented by the following formula (I) is 0.25 to 14250.

A=hydroxyl value (mg KOH/g) of hydroxyl group-containing polyolefin (b)×number of parts by weight of hydroxyl group-containing polyolefin (b) in the adhesive relative to 100 parts by weight of polyolefin (a) (I)

[5] The adhesive tape according to any one of [1] to [4] above, wherein the polyolefin (a) is a polymer having a constitutional unit derived from at least one kind selected from the group consisting of propylene, butene, hexene and octene.
[6] The adhesive tape according to any one of [1] to [5] above, wherein the adhesive layer has a thickness of 1 to 100 μm.
[7] The adhesive tape according to any one of [1] to [6] above, wherein the adhesive layer has a gel fraction of not less than 75% when extracted with an electrolytic solution with a weight ratio of ethylene carbonate and diethyl carbonate of 1:1.
[8] The adhesive tape according to any one of [1] to [7] above, which shows a piercing strength of not less than 300 gf.

### Effect of the Invention

The adhesive tape for non-aqueous battery of the present invention can effectively prevent deformation due to a bamboo-shoot phenomenon and show good anchor property. In addition, the adhesive tape for non-aqueous battery of the present invention has an adhesive layer made of a polyolefin-based adhesive containing polyolefin, and therefore, shows less adverse influence on non-aqueous battery as compared to acrylic adhesive tapes and natural rubber-based adhesive tapes.

### BRIEF DESCRIPTION OF THE DRAWINGS

FIG. 1 is a schematic drawing showing how to peel the adhesive layer from the substrate in the adhesive tape in evaluating the anchor properties of the adhesive tapes prepared in Examples and Comparative Examples.

FIG. 2 includes a schematic drawing of an ABS plate used for the measurement (FIG. 2 (a)), a schematic drawing showing the total width (A₀) of roll-shaped adhesive tape before storage (FIG. 2 (b)), and a schematic drawing showing the total width (A₁) of a roll-shaped adhesive tape after storage (FIG. 2 (c)), in the evaluation of a bamboo-shoot deformation ratio of the roll-shaped adhesive tapes prepared in the Examples and Comparative Examples.

FIG. 3 is a schematic drawing showing the measurement method of the piercing strength of the adhesive tapes prepared in Examples and Comparative Examples.

### DESCRIPTION OF EMBODIMENTS

The adhesive tape for non-aqueous battery of the present invention has a substrate and an adhesive layer. Described below are the various ingredients of the adhesive that forms the adhesive layer [polyolefin (a), hydroxyl group-containing polyolefin (b), crosslinking agent (c) and optional ingredients], followed by an explanation of the adhesive layer and the substrate.

[Polyolefin (a)]

The adhesive contains one or more kinds of polyolefin (a). In the present invention, “a polyolefin” means a polymer having an olefin-derived constitutional unit, and “olefins” include aromatic vinyl compounds such as styrene. Furthermore, “a polymer” as mentioned in the present invention refers to both a homopolymer and a copolymer. The polyolefin (a) may be any polyolefin that can be applied to the substrate in solution in an organic solvent along with other ingredients.

The polyolefin (a) is exemplified by α-olefin homopolymers formed from one monomer selected from the group consisting of ethylene, propylene and C₄₋₂₀ α-olefins. Examples of C₄₋₂₀ α-olefins include 1-butene, 1-pentene, 3-methyl-1-butene, 1-hexene, 4-methyl-1-pentene, 3-methyl-1-pentene, 1-heptene, 1-octene, 1-decene, 1-dodecene and the like. The α-olefin homopolymer is preferably a propylene homopolymer (polypropylene as defined in the narrow sense). Propylene homopolymers include, for example, amorphous polypropylenes and the like.

Other examples of the polyolefin (a) include α-olefin copolymers formed from at least two monomers selected from the group consisting of ethylene, propylene and C₄₋₂₀ α-olefins, with preference given to copolymers comprising ethylene as the main monomer (i.e., ethylene-based α-olefin copolymers) and copolymers comprising propylene as the main monomer (i.e., propylene-based α-olefin copolymers). The α-olefin copolymer may be any of a random copolymer, block copolymer, and graft copolymer.

The amount of ethylene constitutional units in an ethylene-based α-olefin copolymer is, for example, 50 to 95 mol %, preferably 70 to 95 mol %. The α-olefin constitutional units contained in an ethylene-based α-olefin copolymer are preferably those formed from at least one monomer selected from the group consisting of 1-butene, propylene, 1-hexene, and 1-octene. Ethylene-based α-olefin copolymers of greater preference include ethylene-1-butene copolymers and ethylene-propylene copolymers. Such ethylene-1-butene copolymers may contain a constitutional unit derived from an α-olefin other than ethylene and 1-butene at 10 mol % or less. Likewise, ethylene-propylene copolymers may contain a constitutional unit derived from an α-olefin other than ethylene and propylene at 10 mol % or less. Such a copolymer can be produced by, for example, copolymerizing ethylene and an α-olefin using a catalyst consisting of a transition metal catalytic component (e.g., vanadium compounds, zirconium compounds) and an organic aluminum compound catalytic component.

The amount of propylene constitutional units in a propylene-based α-olefin copolymer is, for example, between more than 50 mol % and not more than 95 mol %, preferably 70 to 95 mol %. The α-olefin constitutional units contained in a propylene-based α-olefin copolymer are preferably those formed from at least one monomer selected from the group consisting of ethylene, 1-butene, 1-hexene, and 1-octene. Propylene-based α-olefin copolymers of greater preference are propylene-ethylene random copolymers. The propylene-ethylene random copolymers may contain a constitutional unit derived from an α-olefin other than propylene and ethylene at 10 mol % or less. A propylene-based α-olefin copolymer can be produced by, for example, using a metallocene-based catalyst, as described in JP-A-2000-191862.

Commercially available α-olefin copolymers can be used in the present invention. Commercially available ethylene-based α-olefin copolymers include, for example, the TAFMER P series and the TAFMER A series (both manufactured by Mitsui Chemicals, Inc.), ENGAGE (manufactured by Dow Chemical Co.) and the like. Commercially available propylene-based α-olefin copolymers include, for example, the TAFMER XM series (manufactured by Mitsui Chemicals, Inc.) and the like.

A polymethylpentene can also be used as the polyolefin (a). Polymethylpentenes include homopolymers of 4-methyl-1-pentene and copolymers of 4-methyl-1-pentene and another α-olefin. The amount of 4-methyl-1-pentene constitutional units in a polymethylpentene copolymer is preferably 50 to 95 mol %, more preferably 70 to 95 mol %. The polymethylpentene may be a crystalline polymer. The α-olefin constitutional units in a polymethylpentene copolymer are preferably, for example, those derived from a C₂₋₂₀ α-olefin, such as ethylene, propylene, 1-butene, 1-hexene, 1-octene, 1-decene, 1-tetradecene, or 1-octadecene. Greater preference is given to 1-decene, 1-tetradecene and 1-octadecene, which exhibit good copolymerizability with 4-methyl-1-pentene. Commercially available polymethylpentenes include, for example, TPX-S (a 4-methyl-1-pentene-α-olefin copolymer manufactured by Mitsui Chemicals, Inc.).

The polyolefin (a) may also be any hydride of diene rubber such as polyisoprenes and polybutadienes that are soluble in organic solvents.

The polyolefin (a) is also exemplified by hydrides of block copolymers of a block A composed mainly of a constitutional unit derived from an aromatic vinyl compound (hereinafter sometimes abbreviated as an aromatic vinyl compound unit) and a block B consisting of a constitutional unit derived from isoprene (hereinafter sometimes abbreviated as isoprene unit) and a constitutional unit derived from 1,3-butadiene (hereinafter sometimes abbreviated as 1,3-butadiene unit) (hereinafter sometimes abbreviated as hydrogenated TPE).

Aromatic vinyl compounds include, for example, styrene, α-methylstyrene, o-methylstyrene, m-methylstyrene, p-methylstyrene, t-butylstyrene, N,N-dimethyl-p-aminoethylstyrene, N,N-diethyl-p-aminoethylstyrene, divinylbenzene, vinylpyridine and the like. These may be used alone or in combination of two or more kinds. When using two or more kinds of aromatic vinyl compounds, they may have formed a block structure or a random structure in the block A.

The block A is composed mainly of aromatic vinyl compound units, and may contain constitutional units derived from a diene hydrocarbon such as isoprene or butadiene. The amount of these constitutional units derived from diene hydrocarbons is preferably 20% by weight or less in the block A. When this amount exceeds 20% by weight, the cohesive force of the adhesive layer decreases. As a result, lamination of an adhesive tape on an adherend is not completed by one attempt, and a portion or all of the adhesive layer tends to easily remain on the adherend (so-called adhesive deposit) when the adhesive tape is detached and laminated again. These diene hydrocarbons may have formed a block structure or a random structure in the block A.

The block B consists of isoprene units and 1,3-butadiene units. The state of polymerization of isoprene and 1,3-butadiene may be any of random copolymerization, block copolymerization and tapered block copolymerization. It is preferable that the ethylenic double bond in each isoprene unit and 1,3-butadiene unit be hydrogenated, and that the hydrogenation ratio be 90% or more. This hydrogenation ratio is more preferably 95% or more, more preferably 97% or more. When the hydrogenation ratio is less than 90%, an adverse influence may be exerted on the non-aqueous battery.

Commercial products of hydrogenated TPEs can be used in the present invention. Commercially available hydrogenated TPEs include, for example, SEPTON 4030 (a hydride of styrene-1,3-butadiene-isoprene-styrene block copolymer; amount of styrene constitutional units in the copolymer: 13% by weight; amount of 1,3-butadiene constitutional units in the 1,3-butadiene-isoprene block: 45% by weight) and SEPTON 4033 (a hydride of styrene-1,3-butadiene-isoprene-styrene block copolymer; amount of styrene constitutional units in the copolymer: 30% by weight; amount of 1,3-butadiene constitutional units in the 1,3-butadiene-isoprene block: 50% by weight) manufactured by Kuraray Co. and the like.

As polyolefin (a), a styrene-based thermoplastic elastomer may be used. As the styrene-based thermoplastic elastomer, a product with a hydrogenated ethylenic double bond is preferably used to prevent degradation of the property of non-aqueous battery. Examples of such hydride include hydrides of AB-type diblock copolymer such as styrene-ethylene-butylene copolymer (SEB), styrene-ethylene-propylene copolymer (SEP), styrene-butylene copolymer and the like; hydrides of ABA-type triblock copolymer or ABAB-type tetrablock copolymer such as styrene-ethylene-butylene copolymer-styrene (SEBS), styrene-ethylene-propylene copolymer-styrene (SEPS), styrene-ethylene-butylene copolymer-styrene-ethylene-butylene copolymer (SEBSEB), styrene-butylene-styrene copolymer and the like; hydrides of styrene-ethylene-butylene random copolymer (HSBR); and the like.

As the styrene-based thermoplastic elastomer, hydrides of styrene-based random copolymers such as styrene-butadiene rubber (SBR) and the like, ABC-type styrene-olefin crystal-based block copolymers such as styrene-ethylene-butylene copolymer-olefin crystal (SEBC) and the like can be mentioned.

When using a mixture of a hydrogenated TPE and a styrene-based thermoplastic elastomer as polyolefin (a), the content of the styrene-based thermoplastic elastomer is preferably 50% by weight or less, more preferably 30% by weight or less, in the sum of the hydrogenated TPE and the styrene-based thermoplastic elastomer. When the content is 50% by weight or less, adhesive deposits on the adherend can be suppressed satisfactorily during lamination again.

The polyolefin (a) is also exemplified by isobutylene-based polymers. The isobutylene-based polymers may be isobutylene homopolymers or isobutylene copolymers (i.e., copolymers of isobutylene and another monomer). The amount of isobutylene-derived constitutional units in the isobutylene copolymer is preferably 50% by weight or more. Isobutylene copolymers include, for example, random copolymers of isobutylene and n-butylene, and copolymers of isobutylene and isoprene (regular butyl rubber, chlorinated butyl rubber, brominated butyl rubber, partially crosslinked butyl rubber and the like), as well as vulcanizates and modified products thereof and the like. The isobutylene-based polymer is preferably the homopolymer polyisobutylene.

The polyolefin (a) is preferably a polymer having a constitutional unit derived from at least one kind selected from the group consisting of propylene, butene (also known as butylene), hexene and octene [hereinafter referred to as polyolefin (a-1)]. The butene, hexene and octene may be linear or branched. Polyolefin (a-1) may be a homopolymer or a copolymer. Polyolefin (a-1) is exemplified by the above-described propylene homopolymers (polypropylenes in the narrow sense), propylene-based α-olefin copolymers, hydrogenated TPEs, isobutylene-based polymers and the like. In particular, propylene homopolymers (polypropylenes), hydrogenated TPEs and isobutylene-based polymers are preferable, with greater preference given to propylene homopolymers (polypropylenes) and polyisobutylenes.

The number average molecular weight (Mn) of the polyolefin (a) is preferably 3,000 to 1,000,000, more preferably 4,000 to 800,000. When the number average molecular weight is less than 3,000, the cohesive force may decrease, allowing adhesive deposits to remain on the adherend in some cases when the tape is laminated again. When the same exceeds 1,000,000, the adhesive force may decrease, making it difficult to obtain a desired adhesive force.

The content of the polyolefin (a) in the adhesive is preferably 10 to 99.95% by weight, more preferably 20 to 99.5% by weight. When the content is less than 10% by weight, the adhesive force may decrease, making it difficult to obtain a desired adhesive force. When the same exceeds 99.95% by weight, the adhesion to the substrate may worsen. The “adhesive” which is the basis for calculating the content does not include the amount of organic solvent.

[Hydroxyl Group-Containing polyolefin (b)]

The adhesive contains one or more kinds of hydroxyl group-containing polyolefin (b). The hydroxyl group-containing polyolefin (b) is used to be reacted with the crosslinking agent (c) when forming an adhesive layer. The hydroxyl group-containing polyolefin (b) is preferably one having good compatibility with polyolefins.

The number average molecular weight (Mn) of the hydroxyl group-containing polyolefin (b) is preferably 500 to 500,000, more preferably 1,000 to 200,000, still more preferably 1,200 to 150,000. When the number average molecular weight of the hydroxyl group-containing polyolefin (b) exceeds 500,000, the polyolefin (b) is almost insoluble in the layer with the crosslinking agent (c) as the major ingredient [i.e., a layer with a low content of polyolefin (a)] in the adhesive layer because of the low solubility with the crosslinking agent (c), whereas the hydroxyl group-containing polyolefin (b) mostly dissolves in the layer with the polyolefin (a) as the major ingredient and hence becomes unlikely to react with the crosslinking agent (c), which in turn may make it difficult to obtain satisfactory anchor property. Conversely, when the number average molecular weight of the hydroxyl group-containing polyolefin (b) is less than 500, the hydroxyl group-containing polyolefin (b) is likely to bleed out on the surface of the adhesive layer at high temperatures, which in turn may worsen the adhesive characteristics.

Hydroxyl group-containing polyolefin (b) is not particularly limited and, for example, polyethylene-based polyol, polypropylene-based polyol, polybutadiene polyol, hydrogenated polybutadiene polyol, polyisoprene polyol, and hydrogenated polyisoprene polyol and the like can be mentioned. Of these, hydrogenated polyisoprene polyol, polyisoprene polyol, polybutadiene polyol and hydrogenated polybutadiene polyol are preferable from the aspect of the compatibility with polyolefin (a). When polybutadiene polyol and the like having a double bond are used as hydroxyl group-containing polyolefin (b), the content thereof is desirably limited to not more than 80 parts by weight, preferably not more than 50 parts by weight, relative to 100 parts by weight of polyolefin (a), to avoid an adverse influence on the non-aqueous battery.

It is preferable from the viewpoint of the strength of the adhesive layer that the hydroxyl value (mg KOH/g) of the hydroxyl group-containing polyolefin (b) be 5 or more. From the viewpoint of the adhesive force of the adhesive layer, the hydroxyl value is preferably 95 or less. The hydroxyl value (mg KOH/g) of the hydroxyl group-containing polyolefin (b) is more preferably 10 to 80.

As hydroxyl group-containing polyolefin (b), a commercially available product can be used. Examples of such commercially available product include Poly bd R-45HT (liquid polybutadiene having hydroxyl group on the terminal, number average molecular weight 2800, hydroxyl value 46.6 mg KOH/g, manufactured by Idemitsu Kosan Co., Ltd.), Poly ip (liquid polyisoprene having hydroxyl group on the terminal, number average molecular weight 2500, hydroxyl value 46.6 mg KOH/g, manufactured by Idemitsu Kosan Co., Ltd.), Epole (liquid hydrogenated polyisoprene having hydroxyl group on the terminal, number average molecular weight 2500, hydroxyl value 50.5 mg KOH/g, manufactured by Idemitsu Kosan Co., Ltd.), GI-1000 (liquid polybutadiene having hydroxyl group, number average molecular weight 1500, hydroxyl value 60-75 mg KOH/g, manufactured by Nippon Soda Co., Ltd.), GI-2000 (liquid hydrogenated polybutadiene having hydroxyl group, number average molecular weight 2100, hydroxyl value 40-55 mg KOH/g, manufactured by Nippon Soda Co., Ltd.), GI-3000 (liquid polybutadiene having hydroxyl group, number average molecular weight 3000, hydroxyl value 25-35 mg KOH/g, manufactured by Nippon Soda Co., Ltd.), UNISTOLE P-801 (polyolefin having hydroxyl group, number average molecular weight not less than 5000, hydroxyl value 40 mg KOH/g, manufactured by Mitsui Chemicals, Inc.), UNISTOLE P-901 (polyolefin having hydroxyl group, number average molecular weight not less than 5000, hydroxyl value 50 mg KOH/g, manufactured by Mitsui Chemicals, Inc.) and the like.

The content of the hydroxyl group-containing polyolefin (b) in the adhesive is set so that the value of A represented by the following formula (I) will be preferably 0.25 to 14250, more preferably 0.5 to 12000, still more preferably 1 to 2500.

A=hydroxyl value (mg KOH/g) of hydroxyl group-containing polyolefin (b)×number of parts by weight of hydroxyl group-containing polyolefin (b) in the adhesive relative to 100 parts by weight of polyolefin (a) (I)

When the value of A is smaller than 0.25, the strength of the adhesive layer tends to be insufficient. When the same is greater than 14250, the adhesive force tends to decrease.

[Crosslinking Agent (c)]

The adhesive contains one or more kinds of crosslinking agent (c). The crosslinking agent (c) is used to be reacted with the hydroxyl group-containing polyolefin (b) when forming an adhesive layer. For this reason, the crosslinking agent (c) must have a functional group capable of reacting with the hydroxyl group. Functional groups capable of reacting with the hydroxyl group include, for example, the isocyanate group (also called isocyanato group) and the carboxy group. From the viewpoint of reactivity, the functional group capable of reacting with the hydroxyl group is preferably the isocyanate group. Hence, the crosslinking agent (c) is preferably an isocyanate.

Isocyanate may be any of aromatic isocyanate and aliphatic isocyanate. Isocyanate is preferably aromatic isocyanate.

From the aspects of the strength and the like of the adhesive layer, isocyanate is preferably polyisocyanate having not less than 3 isocyanate groups in one molecule, more preferably at least one selected from a group consisting of aromatic polyisocyanate and aliphatic polyisocyanate, still more preferably at least one selected from a group consisting of an adduct of an aromatic diisocyanate with a polyvalent alcohol and an adduct of an aliphatic diisocyanate with a polyvalent alcohol.

Examples of aromatic diisocyanate include tolylene diisocyanate, diphenylmethane diisocyanate, 1,5-naphthylene diisocyanate, tolidine diisocyanate, xylylene diisocyanate, tetramethylxylylene diisocyanate and the like. Of these, tolylene diisocyanate is preferable from the aspects of reactivity and anchor property of the obtained adhesive layer.

Examples of aliphatic diisocyanate include 1,6-hexamethylene diisocyanate, 1,4-tetramethylene diisocyanate, 2-methyl-1,5-pentane diisocyanate, 3-methyl-1,5-pentane diisocyanate, lysine diisocyanate, isophorone diisocyanate, cyclohexyldiisocyanate, hydrogenated tolylene diisocyanate, hydrogenated xylene diisocyanate, hydrogenated diphenylmethane diisocyanate, hydrogenated tetramethylxylene diisocyanate and the like. Of these, 1,6-hexamethylene diisocyanate is preferable from the aspects of reactivity and anchor property of the obtained adhesive layer.

Examples of polyvalent alcohol include aliphatic polyvalent alcohol such as ethylene glycol, glycerol, trimethylolpropane, pentaerythritol, ditrimethylolpropane, dipentaerythritol and the like, and the like. Of these, trimethylolpropane is preferable.

Examples of polyisocyanate include a compound having an isocyanate group on the terminal obtained by reacting the aforementioned polyvalent alcohol and an excess amount of the aforementioned diisocyanate.

The content of the crosslinking agent (c) is preferably 0.01 to 150 parts by weight, more preferably 0.01 to 20 parts by weight, still more preferably 0.05 to 10 parts by weight, relative to 100 parts by weight of the polyolefin (a). When the content is less than 0.01 parts by weight, the anchor property (i.e., adhesiveness to a substrate) of the adhesive layer may decrease. When the same exceeds 150 parts by weight, adverse effects may arise, including shortening of the pot life of the adhesive solution and reductions of the adhesiveness (i.e., adhesiveness to the adherend) of the adhesive layer.

### [Optional Ingredients of the Adhesive]

The adhesive may contain one or more kinds of optional ingredients. The optional ingredients include, for example, urethane catalysts for promoting the reaction of the hydroxyl group-containing polyolefin (b) and isocyanate [i.e., crosslinking agent (c)]; and the like.

The adhesive may contain one or more kinds of urethane catalysts. Urethane catalysts include, for example, tin compounds such as dibutyltin dilaurate and dioctyltin dilaurate; carboxylates of metals such as zinc, cobalt, copper, and bismuth; amine compounds such as 1,4-diazabicyclo[2.2.2]octane; chelate compounds of metals such as iron, titanium, and zirconium; and the like. Salts of bismuth with organic acid (salts of bismuth with alicyclic organic acids such as salts of bismuth with resin acids containing abietic acid, neoabietic acid, d-pimaric acid, iso-d-pimaric acid, or podocarpic acid, or a combination of two or more kinds thereof, as the major ingredient; salts of bismuth with aromatic organic acids such as benzoic acid, cinnamic acid, and p-oxycinnamic acid; and the like) can also be used. In particular, from the viewpoint of compatibility with the adhesive and urethanization reactivity, iron chelate compounds, dibutyltin dilaurate, dioctyltin dilaurate, and salts of bismuth with resin acids are preferable, with greater preference given to iron chelate compounds in view of their reactivity. Examples of the iron-chelating compound include “Nacem Ferric Iron” (Fe (C₅H₇O₂)₃) manufactured by NIHON KAGAKU SANGYO CO., LTD., and the like.

The content of the urethane catalyst is preferably 0.001 to 2.0 parts by weight, more preferably 0.005 to 1.5 parts by weight, still more preferably 0.008 to 1.0 parts by weight, relative to 100 parts by weight of the polyolefin (a). When the content is less than 0.001 parts by weight, the catalyst effect may be insufficient. When the content exceeds 2.0 parts by weight, drawbacks may arise, such as shortening of the pot life of the adhesive solution. As mentioned herein, the content of catalyst means the amount of the catalyst (i.e., active ingredient) only; when using, for example, a commercially available catalyst solution, the content means the amount of the catalyst only, excluding the amount of the solvent.

Where necessary, the adhesive may contain resin other than the aforementioned polyolefin (a) and hydroxyl group-containing polyolefin (b), antioxidant, UV absorber, light stabilizer such as hindered amine light stabilizer and the like, antistatic agent, filler such as carbon black, calcium oxide, magnesium oxide, silica, zinc oxide, titanium oxide and the like, pigment and the like.

### [Adhesive Layer]

The adhesive layer can be formed by, for example, dissolving the above-described adhesive ingredients in a solvent to yield an adhesive solution, and applying and drying the resulting adhesive solution on a substrate. The solid content of the adhesive solution is not subject to limitations in the present invention, and is normally in the range of 5 to 50% by weight.

The choice of solvent is not subject to limitations, as far as the adhesive ingredients are uniformly soluble therein. Because the adhesive for the present invention contains a polyolefin (a), however, it is preferable that the solvent be one kind of hydrocarbon-based solvent alone, or a mixed solvent of two or more kinds of hydrocarbon-based solvents, or a mixed solvent of a hydrocarbon-based solvent and other solvent. When using a mixed solvent, the content of the hydrocarbon-based solvent is preferably 50% by weight or more, more preferably 70% by weight or more, still more preferably 90% by weight or more, in the mixed solvent. Hydrocarbon-based solvents include, for example, aliphatic hydrocarbons such as n-hexane and n-heptane; alicyclic hydrocarbons such as cyclohexane; and aromatic hydrocarbons such as toluene and xylene. Other solvents include, for example, ketones such as methyl ethyl ketone, cyclohexanone, and acetylacetone; esters such as ethyl acetate; alcohols such as methanol, ethanol, and isopropyl alcohol; and the like.

A method for applying the adhesive solution is not particularly limited, and any publicly known method can be used; for example, methods using kiss-roll coaters, bead coaters, rod coaters, Mayer bar coaters, die coaters, gravure coaters and the like can be used. Also for drying the adhesive solution, any publicly known method can be used. An ordinary method of drying is hot blow drying. Hot blow drying temperature can vary depending on the heat resistance of the substrate, and is normally about 60 to 150° C.

The thickness of the adhesive layer in the adhesive tape (i.e., dried thickness) is preferably 1 to 100 μm, more preferably 2 to 80 μm, still more preferably 3 to 60 μm. When the thickness is less than 1 μm, the adhesiveness (i.e., adhesiveness of the adhesive layer to the adherend) may be insufficient. When the thickness exceeds 100 μm, adhesive deposits on the adherend may occur when the tape is laminated again.

Since the adhesive tape for non-aqueous battery of the present invention is used for the production of non-aqueous batteries, it may contact a non-aqueous electrolytic solution. To prevent degradation of the property of non-aqueous battery, it is preferable that the adhesive layer be eluted less (i.e., high gel fraction) in a non-aqueous electrolytic solution (e.g., mixture of ethylene carbonate and diethyl carbonate). Therefore, the adhesive layer of the adhesive tape for non-aqueous battery of the present invention preferably shows a gel fraction of not less than 75%, more preferably not less than 80%, still more preferably not less than 85%, when extracted with an electrolytic solution with a weight ratio of ethylene carbonate and diethyl carbonate of 1:1. When the gel fraction is less than 75%, the adhesive layer may be eluted too much in the electrolytic solution, making it difficult to suppress degradation of the non-aqueous battery.

In the present invention, the gel fraction of an adhesive layer is measured and calculated as follows. First, about 0.2 g or less of the adhesive layer is obtained from an adhesive tape, and the weight (W₀) of the adhesive layer before immersion in an electrolytic solution is measured. Then, the obtain adhesive layer is immersed in an electrolytic solution (ethylene carbonate:diethyl carbonate=1:1 (weight ratio), temperature 60° C., volume 50 mL) for 3 days, and the soluble content of the adhesive layer is extracted. After the immersion, the insoluble adhesive layer is removed, the adhesive layer is heated at 120° C. for 1 hr to remove the electrolytic solution from the adhesive layer, and the weight (W₁) of the adhesive layer after immersion in an electrolytic solution is measured. The gel fraction is calculated according to the following formula.

gel fraction (%)=100×W₁/W₀

W₀: weight (g) of adhesive layer before immersion in electrolytic solution

W₁: weight (g) of adhesive layer after immersion in electrolytic solution

The gel fraction is measured and calculated 3 times as mentioned above, and the average value thereof is taken as the gel fraction in the present invention.

### [Substrate]

In the present invention, the substrate is not particularly limited, and various substrates can be used. Examples of the substrate include fiber-based substrates such as cloth, non-woven fabric, felt, net and the like; paper-based substrates such as various kinds of paper and the like; metal-based substrates such as metal foil, metal plate and the like; plastic-based substrates such as film, sheet and the like made of various resins; rubber-based substrate such as rubber sheet and the like; foams such as foamed sheet and the like; and laminates of these; and the like. Examples of the material of the plastic-based substrate include polyester (e.g., poly(ethylene terephthalate), poly(ethylene naphthalate), poly(butylene terephthalate), poly(butylene naphthalate)), polyolefin (e.g., polyethylene, polypropylene, ethylene-propylene copolymer), polyvinyl alcohol, polyvinyldene chloride, polyvinyl chloride, vinyl chloride-vinyl acetate copolymer, polyvinyl acetate, polyamide, polyimide, celluloses, fluorine resin, polyether, polyetheramide, polyphenylene sulfide, polystyrene-based resin (e.g., polystyrene), polycarbonate, polyether sulfone and the like. Of these, plastic-based substrates such as polyimide, polyphenylene sulfide, polyolefin (e.g., polypropylene) and the like are preferable, since they are not easily decomposed and degraded in an electrolytic solution. The substrate may be a single layer or a multilayer.

In addition, to enhance anchor property (i.e., adhesiveness of adhesive layer and substrate), the surface of the substrate may be subjected as necessary to a known chemical or physical surface treatment (e.g., chromate treatment, exposure to ozone, exposure to flame, exposure to high-pressure electrical shock, ionizing radiation treatment etc.).

While the thickness of the substrate is not particularly limited, it is, for example, about 8-100 μm, preferably about 10-50 μm. When the thickness of the substrate is too thin, the strength of the adhesive tape becomes too low, possibly impairing practical utility. On the other hand, when the thickness of the substrate is too high, the volume of the adhesive tape in a non-aqueous battery becomes too high, possibly adversely influencing high capacity of the battery.

As the substrate, a low water-absorptive substrate is preferable. When a high water-absorptive substrate is used, decomposition of a solute component in a non-aqueous electrolytic solution may be promoted, possibly adversely influencing the property and life of the non-aqueous battery. Examples of the low water-absorptive substrate include plastic-based substrates made of polyimide, polyphenylene sulfide, polypropylene and the like.

As the substrate, a substrate having high electric resistance, for example, a plastic-based substrate made of polyimide, polyphenylene sulfide, polyester, polypropylene etc. is preferable.

As the substrate, a substrate having a high piercing strength is preferable. Using such substrate, an adhesive tape having a high piercing strength can be obtained. An adhesive tape having a low piercing strength cannot sufficiently protect a separator from burr present in a polar plate and mixed contaminants, and the separator may have a pore. As a result, short-circuit (short) of a positive electrode plate and a negative electrode plate in a non-aqueous battery may not be prevented.

The piercing strength of an adhesive tape and that of a substrate are both preferably not less than 300 gf, more preferably not less than 450 gf. The upper limit of these piercing strengths is, for example, 1400 gf. Examples of the substrate having high piercing strength include plastic-based substrates made of polyimide, polyphenylene sulfide, polyester, polypropylene etc.

In the present invention, the piercing strength of an adhesive tape is measured and calculated as follows. First, an adhesive tape is fixed with two pieces of clamping plate having a circular hole (diameter 11±0.5 mm). A piercing needle (needle diameter 0.5 mm) is pierced at a rate of 2 mm/s in an atmosphere of temperature 23±2° C. from the center part of the circular hole, and the maximum load (gf) at the time of penetration of the piercing needle through the adhesive tape is measured. The maximum load is measured 10 times, and the average value is taken as a “piercing strength”. The measurement and calculation method of the piercing strength of a substrate is the same as the measurement and calculation method of the piercing strength of the aforementioned adhesive tape except that the adhesive tape is changed to the substrate.

### [Release Agent Layer]

The adhesive tape of the present invention may have a release agent layer to protect the adhesive layer. For example, the adhesive tape of the present invention may have a release agent layer on the substrate on the side opposite to the adhesive layer (i.e., the “adhesive layer/substrate/release agent layer” configuration). In this configuration, the release agent layer is sometimes called a back coating layer, and the adhesive tape is sometimes called an adhesive tape with a back coating layer.

To protect the adhesive layer of the adhesive tape of the present invention, a release material having a release agent layer formed on the substrate thereof may be used. Specifically, by bringing into mutual contact the adhesive layer of the adhesive tape of the present invention and the release agent layer of the release material, the adhesive layer may be protected (i.e., the “substrate of adhesive tape/adhesive layer/release agent layer/substrate of release material” configuration). An adhesive tape in this configuration is also called an adhesive tape with a release material.

### [Applications]

The adhesive tape for non-aqueous battery of the present invention can be used to produce a non-aqueous battery (i.e., battery encapsulating non-aqueous electrolytic solution). The non-aqueous electrolytic solution is not particularly limited and, for example, a mixture of cyclic carbonate (e.g., propylene carbonate (PC), ethylene carbonate (EC) and the like) and acyclic carbonate (e.g., dimethyl carbonate (DMC), ethylmethyl carbonate (EMC), diethyl carbonate (DEC) and the like) and the like can be mentioned. Of these, a mixture of ethylene carbonate and diethyl carbonate is representative. The adhesive tape for non-aqueous battery of the present invention is preferably used for the production of a lithium-ion battery.

### [Physical Properties, Characteristics and the Like]

The values of physical properties, characteristics and the like given herein are measured values obtained by the methods shown below.

### (1) Number Average Molecular Weight

A value determined in accordance with ASTM D2503.

### (2) Hydroxyl Value

A value determined in accordance with JIS K1557:1970.

### EXAMPLES

The present invention is hereinafter described more specifically by means of the following Examples and Comparative Examples, which, however, do not limit the scope of the invention.

### [Preparation of Adhesive Solution]

Various ingredients were blended in the numbers of parts shown in Tables 1 and 2, and this mixture was dissolved in toluene to yield an adhesive solution having a solid content of 10% by weight. The numbers of parts of the various ingredients shown in Table 1 do not include the solvent. Hence, the numbers of parts shown in Table 1 indicate the numbers of parts of the ingredients themselves (solid contents) contained in the solution, provided that the ingredients are obtained in solution. Also shown in Table 1 are values of A in the formula (I) above.

Abbreviations of each component in Table 1 mean the following.

### (1) Polyolefin (a)

B80: “Oppanol B80” (polyisobutylene, number average molecular weight 180,000) manufactured by BASF Japan Ltd.

B12: “Oppanol B12” (polyisobutylene, number average molecular weight 13,000) manufactured by BASF Japan Ltd.

### (2) Hydroxyl Group-Containing Polyolefin (b)

Epole: “Epole” (liquid hydrogenated polyisoprene having hydroxyl group on the terminal, number average molecular weight 2500, hydroxyl value 50.5 mg KOH/g) manufactured by Idemitsu Kosan Co., Ltd.

### (3) Crosslinking Agent (c)

C/L: “CORONATE L” (75% by weight ethyl acetate solution of adduct of tolylene diisocyanate with trimethylolpropane, isocyanate group number in one molecule: 3) manufactured by Nippon Polyurethane Industry Co., Ltd.

### [Preparation of Adhesive Tape]

An adhesive solution prepared as mentioned above is sent out by a pump, and applied to the inner surface of a wound substrate by using a reverse roll coater. The substrate applied with the adhesive solution was dried in a drying tower at 80° C. to form an adhesive layer. The substrate having the formed adhesive layer was wound to give an original fabric (i.e., roll-shaped adhesive tape before processing into a product shape).

As a substrate of an adhesive tape, “Torayfan B02548” (biaxially-oriented polypropylene film after corona discharge treatment of both surfaces, thickness 30 μm, manufactured by Toray Industries, Inc.) was used. An adhesive solution was applied such that the dried thickness of the adhesive layer of an adhesive tape (i.e., adhesive thickness) was 7 μm. In addition, 700 m of the original fabric was wound. During the winding, a long-chain alkyl-based release agent was applied to the outer surface of the substrate and dried to form a release agent layer (back coating layer).

The original fabric obtained as mentioned above was wound around a core (3 inch core, width 15 mm, inner diameter 76 mm) while cutting with a slit blade adjusted to have a pitch of 15 mm, whereby a roll-shaped adhesive tape (width 15 mm) was prepared. The roll-shaped adhesive tape (500 m wound) was used as a sample for the evaluation of the below-mentioned bamboo-shoot deformation ratio.

### [Evaluation of Adhesive Tape]

The anchor property, bamboo-shoot deformation ratio and piercing strength of the obtained adhesive tape, and the gel fraction of the adhesive layer were evaluated as follows.

### (1) Anchor Effect

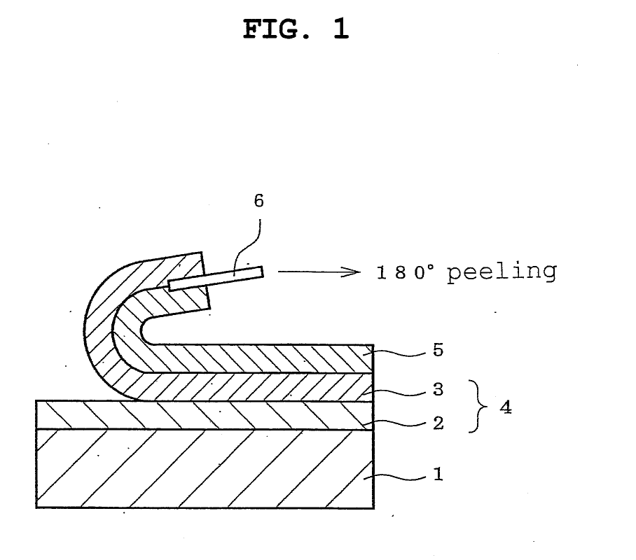

An SUS plate was attached as a backing to the substrate of an adhesive tape (width 15 mm) using a double-coated adhesive tape. The sample adhesive tape and a 14 mm wide cut piece of No. 315 Tape (a rubber-based adhesive manufactured by NITTO DENKO CORPORATION) were laminated together in a way such that the glue surface of No. 315 Tape came into contact with the adhesive layer of this adhesive tape. In this operation, a filler paper cord was sandwiched between these tapes. While the filler paper cord was being carried by a fastener, the No. 315 Tape was pulled in a 180° direction at a speed of 100 m/min using a tensile tester to detach the adhesive layer from the adhesive tape. The force required for the detaching (i.e., the anchoring force required for detaching the adhesive layer from the substrate) was measured. The results are shown in Table 1. How to separate the adhesive layer from the substrate of the adhesive tape is schematized in FIG. 1.

Regarding the detachment form of the adhesive layer from the substrate, a sensory evaluation was performed to determine the touch of the adhesive tape substrate surface after removing the adhesive layer. When a touch of the adhesive was felt (i.e., a portion of the adhesive layer remained on the substrate upon removal), the sample was given the rating “cohesion failure”. When only a touch of the substrate was felt (i.e., the entire adhesive layer was removed), the sample was given the rating “anchor failure”. The results are shown in Table 1.

### (2) Bamboo-Shoot Deformation Ratio

A string was passed through the core of a roll-shaped adhesive tape (width 15 mm, length 500 m) prepared as mentioned above, and an adhesive tape was suspended on this string. The suspended adhesive tape was stored under the atmosphere of temperature 40° C. and humidity 92% RH for 32 days. The total widths of the roll-shaped adhesive tape before and after storage were measured, and the bamboo-shoot deformation ratio (%) was calculated by the following formula. The results are shown in Table 1.

bamboo-shoot deformation ratio (%)=100×(A₁−A₀)/A₀

A₀: total width (mm) of roll-shaped adhesive tape before storage

A₁: total width (mm) of roll-shaped adhesive tape after storage

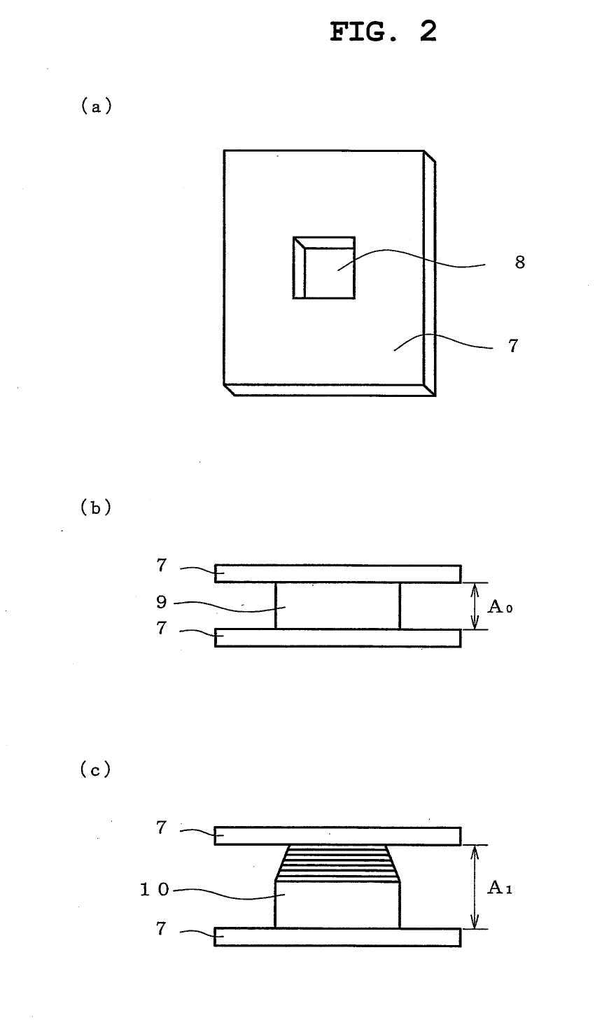

The total widths of the roll-shaped adhesive tape before and after storage were measured as follows. First, two pieces of ABS plate (2 mm×210 mm×297 mm) were prepared, and a square hole (4 cm×4 cm) was cut out in the central part of the ABS plates (FIG. 2 (a)). The roll-shaped adhesive tapes before and after storage were sandwiched between these ABS plates (FIG. 2 (b) and FIG. 2 (c)), and the total width of the roll-shaped adhesive tape was measured at the four corners of the square hole in the ABS plate. The four measured values were averaged to calculate the total width of the roll-shaped adhesive tape.

### (3) Piercing Strength

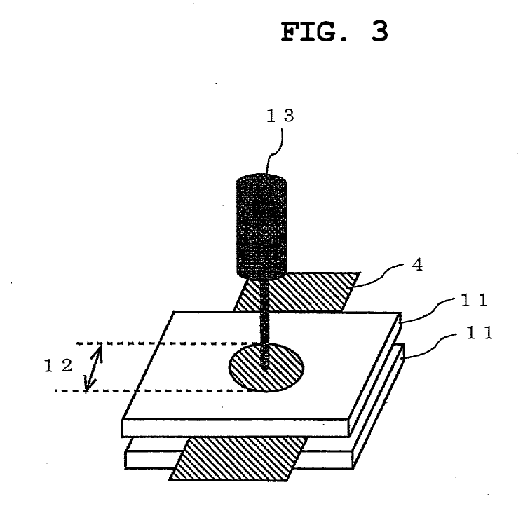

Using a compression tester (trade name “KES-G5”, manufactured by Kato tech Co., Ltd., diameter of circular hole of clamping plate 11.28 mm), the piercing strength of an adhesive tape was measured by the aforementioned method. The results are shown in Table 1. A schematic drawing of the measurement method of the piercing strength is shown in FIG. 3.

### (4) Gel Fraction of Adhesive Layer

About 0.0700 g of an adhesive layer was obtained from an adhesive tape, and the gel fraction of the adhesive layer was measured by the aforementioned method. The results are shown in Table 1.

TABLE 1

| | | | anchor property | | bamboo- | | gel |
|---|---|---|---|---|---|---|---|
| | | | | anchoring | shoot | piercing | fraction |
| | composition of adhesive | A | detachment | force | deformation | strength | of adhesive |
| | (parts by weight) | value | form | (N/14 mm) | ratio (%) | (gf) | layer (%) |
| Example 1 | B80:B12:Epole:C/L = 100:25:2:3 | 80.8 | cohesion | 12< | 1 | 750 | 88 |
| | | | failure | | | | |
| Comparative | B80:B12 = 100:25 | — | anchor | 1.0 | 11 | 750 | 85 |
| Example 1 | | | failure | | | | |
| Comparative | B80:B12:C/L = 100:25:3 | — | anchor | 1.5 | —* | 750 | 87 |
| Example 2 | | | failure | | | | |
| Comparative | B80:B12:Epole = 100:25:2 | 80.8 | anchor | 0.7 | —* | 750 | 86 |
| Example 3 | | | failure | | | | |

*not measured

Referring to Table 1, in the adhesive tapes having an adhesive layer formed with an adhesive containing a polyolefin (a), a hydroxyl group-containing polyolefin (b) and a crosslinking agent (c) (Example 1), the detachment form between the substrate and the adhesive layer was judged to be a cohesion failure; these tapes were shown to have an excellent anchor property. In contrast, in the adhesive tapes having an adhesive layer formed with an adhesive containing none or only one of the hydroxyl group-containing polyolefin (b) and the crosslinking agent (c) (Comparative Examples 1 to 3), an anchor failure occurred; these tapes were shown to have a poor anchor property.

Moreover, the bamboo-shoot deformation ratio of the adhesive tape of Example 1 was 1%, whereas that of the adhesive tape of Comparative Example 1 was 11%. The results reveal that the adhesive tape of the present invention can effectively suppress deformation due to a bamboo-shoot phenomenon.

### INDUSTRIAL APPLICABILITY

The adhesive tape for non-aqueous battery of the present invention is useful for the production of a non-aqueous battery, particularly lithium-ion battery.

### EXPLANATION OF SYMBOLS

1 SUS plate
2 substrate
3 adhesive layer
4 adhesive tape
5 “No. 315 tape” manufactured by NITTO DENKO CORPORATION
6 filler paper cord
7 ABS plate
8 square hole
9 roll-shaped adhesive tape before storage
10 roll-shaped adhesive tape after storage
11 clamping plate
12 diameter (11.28 mm) of circular hole
13 piercing needle

1. An adhesive tape for non-aqueous battery, comprising a substrate and an adhesive layer laminated on at least one surface of the substrate, wherein the adhesive layer is made of an adhesive comprising a polyolefin (a), a hydroxyl group-containing polyolefin (b) and a crosslinking agent (c) having a functional group capable of reacting with the hydroxyl group.

2. The adhesive tape according to claim 1, wherein the crosslinking agent (c) is an isocyanate.

3. The adhesive tape according to claim 1, wherein the content of the crosslinking agent (c) in the adhesive is 0.01 to 150 parts by weight relative to 100 parts by weight of the polyolefin (a).

4. The adhesive tape according to claim 1, wherein the value of A represented by the following formula (I) is 0.25 to 14250.
A=hydroxyl value (mg KOH/g) of hydroxyl group-containing polyolefin (b)×number of parts by weight of hydroxyl group-containing polyolefin (b) in the adhesive relative to 100 parts by weight of polyolefin (a) (I)

5. The adhesive tape according to claim 1, wherein the polyolefin (a) is a polymer having a constitutional unit derived from at least one kind selected from the group consisting of propylene, butene, hexene and octene.

6. The adhesive tape according to claim 1, wherein the adhesive layer has a thickness of 1 to 100 μm.

7. The adhesive tape according to claim 1, wherein the adhesive layer has a gel fraction of not less than 75% when extracted with an electrolytic solution with a weight ratio of ethylene carbonate and diethyl carbonate of 1:1.

8. The adhesive tape according to claim 1, which shows a piercing strength of not less than 300 gf.
